(19) United States
(12) Patent Application Publication
(10) Pub. No.: US 2025/0362552 A1
(43) Pub. Date: Nov. 27, 2025

(54) DISPLAY PANEL AND DISPLAY DEVICE CAPABLE OF SUPPRESSING REDUCTION IN APERTURE RATIO

(71) Applicant: Sharp Display Technology Corporation, Kameyama City (JP)

(72) Inventors: Kuniaki OKADA, Kameyama City (JP); Seiichi UCHIDA, Kameyama City (JP)

(21) Appl. No.: 19/194,395

(22) Filed: Apr. 30, 2025

(30) Foreign Application Priority Data
May 24, 2024 (JP) 2024-084989

(51) Int. Cl. G02F 1/1362; G02F 1/1339; G02F 1/1343

(52) U.S. Cl. CPC G02F 1/136222; G02F 1/1339; G02F 1/134309; G02F 1/136286

(57) ABSTRACT

A liquid crystal panel includes an array substrate, a counter substrate, and spacers for maintaining a gap between the array substrate and the counter substrate. The array substrate includes source wiring lines extending in a first direction, gate wiring lines extending in a second direction intersecting the first direction, a first electrode row obtained by pixel electrodes being arrayed in the first direction, a second electrode row adjacent to the first electrode row and obtained by pixel electrodes being arrayed in the first direction, and first light blocking portions disposed at locations overlapping the spacers in a plan view. One of the counter substrate or the array substrate includes a first color filter and a second color filter overlapping the pixel electrodes of the first electrode row in a plan view and alternately provided in the first direction, and a third color filter overlapping the pixel electrodes of the second electrode row in a plan view and provided in the first direction. The spacers are provided in the second electrode row.

### CROSS-REFERENCE TO RELATED APPLICATIONS

This application claims the benefit of priority to Japanese Patent Application Number 2024-084989 filed on May 24, 2024. The entire contents of the above-identified application are hereby incorporated by reference.

### BACKGROUND

### Technical Field

The techniques described in the present specification relate to a display panel and a display device capable of suppressing a reduction in aperture ratio.

A pixel of a display panel such as a liquid crystal panel is constituted by a plurality of subpixels of different colors. In the related art, one pixel is constituted by three subpixels of red (R), green (G), and blue (B). In recent years, however, techniques that increase the (apparent) resolution in specifications with fewer subpixels (so-called subpixel rendering) have been proposed, with one example being described in JP 2019-184816 A. The liquid crystal panel described in JP 2019-184816 A realizes subpixel rendering by a pixel layout in which subpixels are arrayed in a PenTile arrangement.

Further, J P 2019-184816 A discloses that spacers for keeping a gap between two substrates (array substrate and counter substrate) in which a liquid crystal layer is enclosed are arranged at a boundary between subpixels of different colors. Further, no spacers are arranged in a specific portion of the boundary, making it possible to suppress a reduction in aperture ratio associated with the arrangement of the spacers.

### SUMMARY

In the manufacturing process of the liquid crystal panel, the array substrate and the counter substrate are bonded to each other with spacers interposed therebetween. During this bonding, positional displacement (fitting misalignment) may occur in planar locations of the two substrates. With the spacers described in JP 2019-184816 A being disposed at the boundary between the subpixels of different colors, there is a concern that this positional displacement may cause variation in a balance of the aperture ratios of the subpixels of each color, changing a chromaticity to a value different from a design value. Further, when a light blocking portion of the spacer is formed in consideration of the positional displacement to address this issue, a reduction in aperture ratio occurs.

The techniques described herein have been made on the basis of such circumstances described above, and an object thereof is to suppress a reduction in aperture ratio.
(1) A display panel according to the techniques described in the present specification includes an array substrate, a counter substrate, and a plurality of spacers configured to maintain a gap between the array substrate and the counter substrate. The array substrate and the counter substrate are disposed facing each other. The array substrate includes a plurality of source wiring lines extending in a first direction, a plurality of gate wiring lines extending in a second direction intersecting the first direction, a first electrode row obtained by a plurality of pixel electrodes being arrayed in the first direction, a second electrode row adjacent to the first electrode row and obtained by a plurality of pixel electrodes being arrayed in the first direction, and a plurality of first light blocking portions disposed at locations overlapping the plurality of spacers in a plan view. One of the counter substrate or the array substrate includes a first color filter and a second color filter overlapping the plurality of pixel electrodes of the first electrode row in a plan view and alternately provided in the first direction, and a third color filter overlapping the plurality of pixel electrodes of the second electrode row in a plan view and provided in the first direction. The plurality of spacers are provided in the second electrode row in which the third color filter is disposed.
(2) Further, in the display panel described above, in addition to (1) described above, the first color filter may be a red color filter, the second color filter may be a blue color filter, and the third color filter may be a green color filter.
(3) Further, in the display panel described above, in addition to (1) or (2) described above, the counter substrate may include a second light blocking portion overlapping a boundary between the first color filter and the second color filter in a plan view, and may not include a light blocking portion overlapping the third color filter in a plan view.
(4) Further, in the display panel describe above, in addition to (3) described above, a length of the second light blocking portion in the first direction may be greater than a length of the plurality of gate wiring lines in the first direction.
(5) Further, in the display panel described above, in addition to any one of (1) to (4) described above, the plurality of spacers and the plurality of first light blocking portions may be provided at locations overlapping the plurality of gate wiring lines in a plan view.
(6) Further, the display panel described above, in addition to any one of (1) to (5) described above, may include a plurality of the second electrode rows. When the plurality of gate wiring lines arranged in order in the first direction are represented by a first gate wiring line, a second gate wiring line, a third gate wiring line, and a fourth gate wiring line, first light blocking portions of the plurality of first light blocking portions in one of the plurality of second electrode rows may be provided at locations overlapping the first gate wiring line and the third gate wiring line, and first light blocking portions of the plurality of first light blocking portions in another second electrode row of the plurality of second electrode rows, the other second electrode row being adjacent to the one second electrode row with the first electrode row interposed therebetween, may be provided at locations overlapping the second gate wiring line and the fourth gate wiring line.
(7) Further, in the display panel described above, in addition to any one of (1) to (6) described above, the array substrate may include the first color filter, the second color filter, and the third color filter.
(8) Further, in the display panel described above, in addition to (7) described above, a length of the third color filter in the second direction may be less than a length of the first color filter in the second direction and a length of the second color filter in the second direction.
(9) Further, the display panel described above, in addition to any one of (1) to (8) described above, may include a liquid crystal layer between the array substrate and the counter substrate.
(10) A display device according to the techniques described in the present specification includes the display panel according to any one of (1) to (10) described above.

According to the techniques described in the present specification, a reduction in aperture ratio can be suppressed.

### BRIEF DESCRIPTION OF DRAWINGS

The disclosure will be described with reference to the accompanying drawings, wherein like numbers reference like elements.

FIG. 1 is a perspective view of a liquid crystal display device according to a first embodiment.

FIG. 2 is a cross-sectional view of a liquid crystal panel.

FIG. 3 is a circuit diagram illustrating a pixel arrangement in a display region of an array substrate.

FIG. 4 is a plan view illustrating a layout of source wiring lines, gate wiring lines, and spacer light blocking portions of the array substrate.

FIG. 5 is a plan view illustrating a layout of color filters, black matrices, and spacers of a counter substrate.

FIG. 6 is a plan view of a liquid crystal panel with FIG. 4 and FIG. 5 superimposed.

FIG. 7 is a plan view illustrating a configuration layout of one subpixel of the liquid crystal panel.

FIG. 8 is a cross-sectional view of the liquid crystal panel taken along line III-III in FIG. 7.

FIG. 9 is a cross-sectional view of the liquid crystal panel taken along line I-I in FIG. 6.

FIG. 10 is a cross-sectional view of the liquid crystal panel taken along the line II-II in FIG. 6.

FIG. 11 is a plan view illustrating a layout of the color filters, black matrices, and the spacers of a counter substrate according to a first comparative example.

FIG. 12 is a cross-sectional view of a liquid crystal panel according to the first comparative example taken along line IV-IV in FIG. 11.

FIG. 13 is a plan view illustrating a liquid crystal panel according to another embodiment.

FIG. 14 is a cross-sectional view of the liquid crystal panel in FIG. 13 taken along line III-III in FIG. 7.

FIG. 15 is a plan view illustrating a liquid crystal panel according to another embodiment.

### DESCRIPTION OF EMBODIMENTS

### First Embodiment

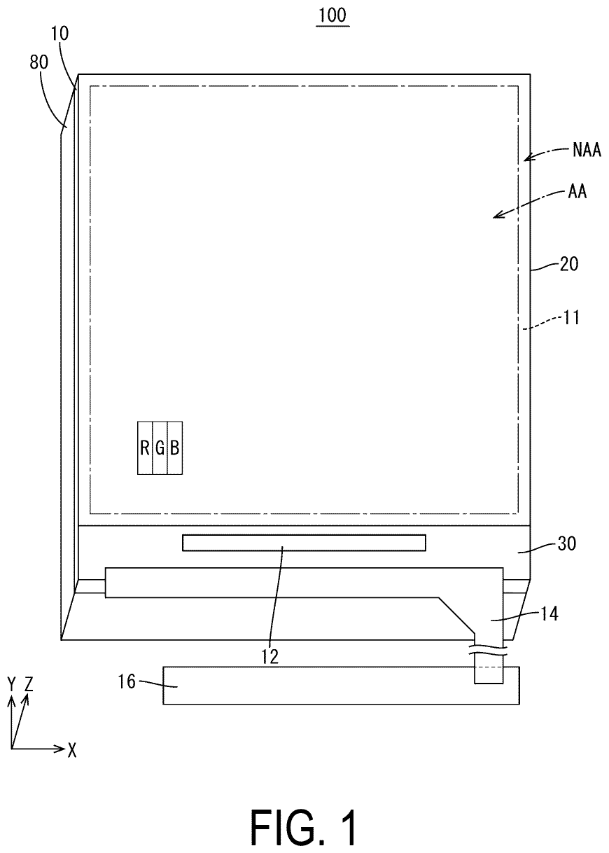

A liquid crystal display device 100 (example of display device) according to a first embodiment will be described with reference to FIG. 1 to FIG. 10. Note that an X-axis, a Y-axis, and a Z-axis are illustrated in some of the drawings, and directions of these directions are drawn so as to be common in each of the drawings. Further, a +Z direction corresponds to a front side (display surface side), and a −Z direction corresponds to a back side.

As illustrated in FIG. 1, the liquid crystal display device 100 includes a liquid crystal panel 10 (example of display panel) that displays an image, a driver 12 that drives the liquid crystal panel 10, a control substrate 16 that supplies various signals to the driver 12, a flexible substrate 14 that electrically connects the liquid crystal panel 10 and the control substrate 16, and a backlight device 80 (example of an illumination device) that is an external light source disposed on a back side of the liquid crystal panel 10 and irradiates the liquid crystal panel 10 with light for display. The liquid crystal panel 10 according to the present embodiment is used for a head-mounted display, for example, and has an extremely high resolution. A pixel density of the liquid crystal panel 10 is, for example, within a range of about from 700 ppi to 2000 ppi.

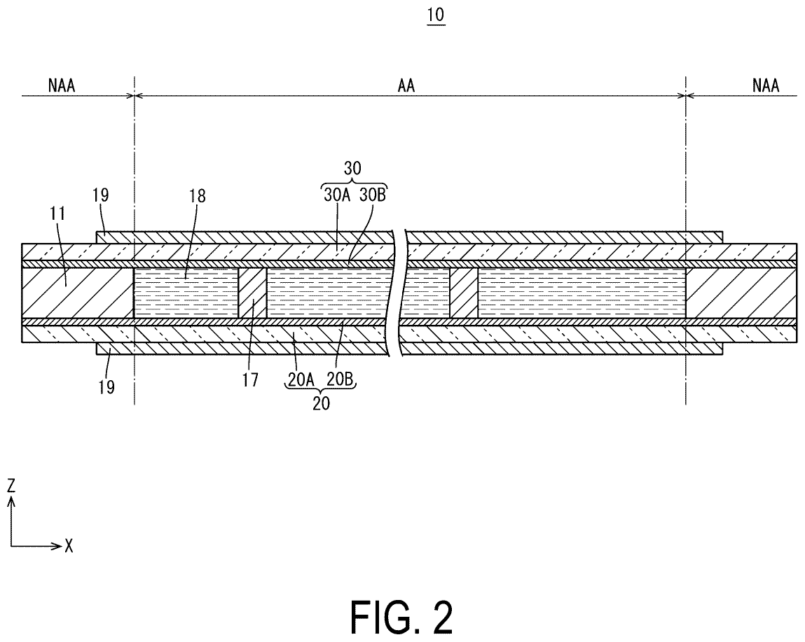

As illustrated in FIG. 1 and FIG. 2, within the plane of the liquid crystal panel 10, the liquid crystal panel 10 is divided into a display region (active area) AA capable of displaying an image and disposed on a center side, and a non-display region (non-active area) NAA disposed on an outer periphery side and having a frame-like shape surrounding the display region AA in a plan view. A planar shape of the liquid crystal panel 10 is not limited. Pixels are arrayed in the liquid crystal panel 10, and a long side direction, a short side direction, and a thickness direction of the pixels respectively coincide with a Y direction (example of first direction), an X direction (example of second direction), and a Z direction.

The liquid crystal panel 10, as illustrated in FIG. 2, includes a pair of substrates 20, 30, and a liquid crystal layer 18 (example of a medium layer) including liquid crystal molecules that change in optical characteristics according to application of an electrical field. Between the substrates 20, 30, a plurality of spacers (photospacers) 17 having a columnar shape are provided penetrating the liquid crystal layer 18. A gap (cell gap) between the substrates 20, 30 is kept constant across the entire surface by the plurality of spacers 17. Both of the substrates 20, 30 are bonded together by a sealant 11 in a state of maintaining the cell gap at a thickness equivalent to that of the liquid crystal layer 18, enclosing the liquid crystal layer 18 in an internal space thereof. Further, polarizers 19 are bonded to outer face sides of both of the substrates 20, 30, respectively.

Of the pair of substrates 20, 30, one disposed on the back side is a counter substrate 20, and the other disposed on the front side (display surface side) is an array substrate (active matrix substrate, thin film transistor (TFT) substrate) 30. The counter substrate 20 and the array substrate 30 each have a configuration formed by layering various films 20B, 30B on an inner face side (liquid crystal layer 18 side) of glass substrates 20A, 30A (example of insulating substrate) having transparency. The counter substrate 20 and the array substrate 30 are manufactured by layering various films on the glass substrates 20A, 30A while patterning the films using a known photolithography method. An alignment film is applied to an uppermost layer (layer closest to the liquid crystal layer 18) of each of the counter substrate 20 and the array substrate 30 so as to cover the layered films formed by a photolithography method.

The spacer 17 need only be formed on one of the substrate 20 or 30 in the manufacturing process, and is formed on the counter substrate 20 in the present embodiment. The spacer 17 is made of a resin material that is transparent and cured by light or heat, for example, and is substantially transparent. The resin material is, for example, an organic insulating material such as an acrylic resin (such as polymethyl methacrylate (PMMA)) or a polyimide resin. Therefore, spacer light blocking portions 41 (example of first light blocking portion) for preventing light leakage from the locations where the spacers 17 are arranged are formed on at least one of the substrate 20 or 30. As described below, the spacer light blocking portions 41 according to the present embodiment are provided at locations overlapping the spacers 17 in the array substrate 30 in a plan view.

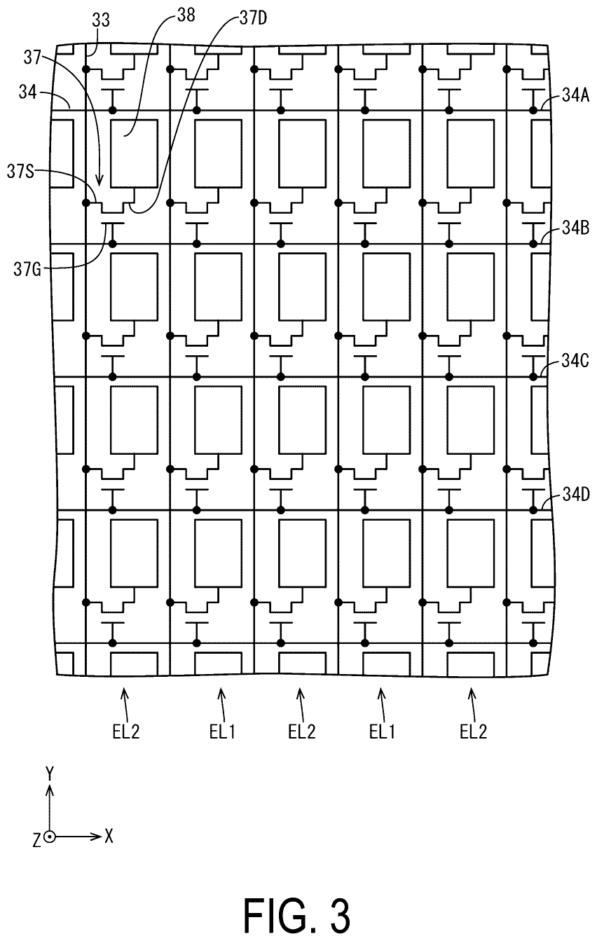

In the display region AA of the array substrate 30, as illustrated in FIG. 3, a large number of source wiring lines (data lines, signal lines) 33 extending in the Y direction and gate wiring lines (scanning lines) 34 extending in the X direction intersecting the source wiring lines 33 are formed in a lattice pattern. TFTs 37, which are switching elements, and pixel electrodes 38 are formed in each region surrounded by the source wiring lines 33 and the gate wiring lines 34. A large number of the TFTs 37 and the pixel electrodes 38 are arrayed in a matrix across the display region AA as a whole.

A plurality of the pixel electrodes 38 arranged in one row in the Y direction is referred to as an electrode row. A first electrode row EL1 and a second row electrode row EL2 adjacent thereto are alternately arrayed in the X direction. As described below, red (R) color filters 22R (example of first color filter) and blue (B) color filters 22B (example of second color filter) provided on the counter substrate 20 are alternately arrayed along the first electrode row EL1. Further, a green (G) color filter 22G (example of third color filter) is arrayed along the second electrode row EL2.

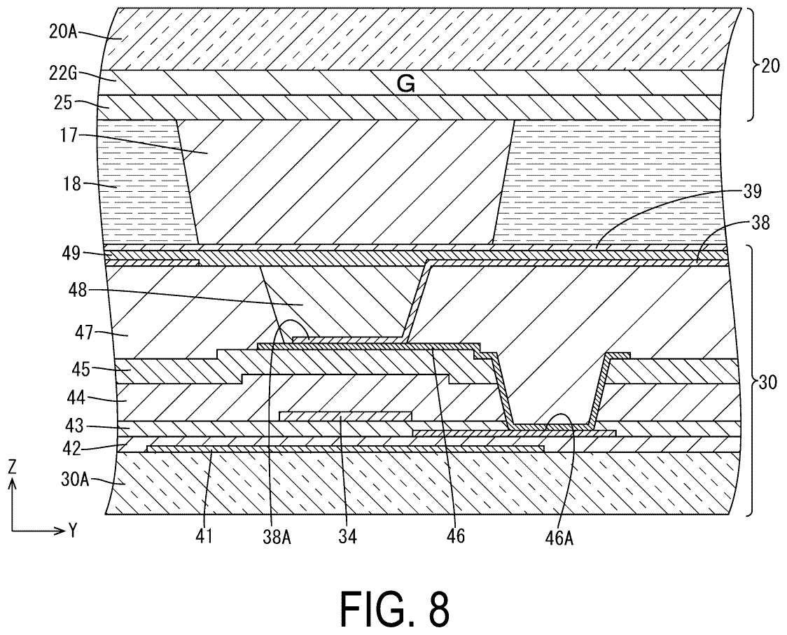

A common electrode 39 (refer to FIG. 8) supplied with a reference potential is provided in the display region AA of the array substrate 30. When signals are input from the source wiring line 33 and the gate wiring line 34 to the TFT 37, the pixel electrode 38 connected to the TFT 37 is charged, and a potential difference between the pixel electrode 38 and the common electrode 39 changes. Through the control of the electrical field applied to the liquid crystal layer 18 by this potential difference, an alignment state of liquid crystal molecules is appropriately switched, driving the liquid crystal panel 10.

The source wiring lines 33 are connected to the driver 12 via lead-out wiring lines, and data signals (image signals) are supplied to the source wiring lines 33 from a source drive circuit in the driver 12. The gate wiring lines 34 are connected to a gate driver monolithic circuit (GDM, gate drive circuit) portion monolithically formed in the non-display region NAA, and a scanning signal is supplied from the GDM portion to the gate wiring lines 34. The GDM portion is connected to the flexible substrate 14 via the lead-out wiring line, and is supplied with a signal from the control substrate 16 through the flexible substrate 14.

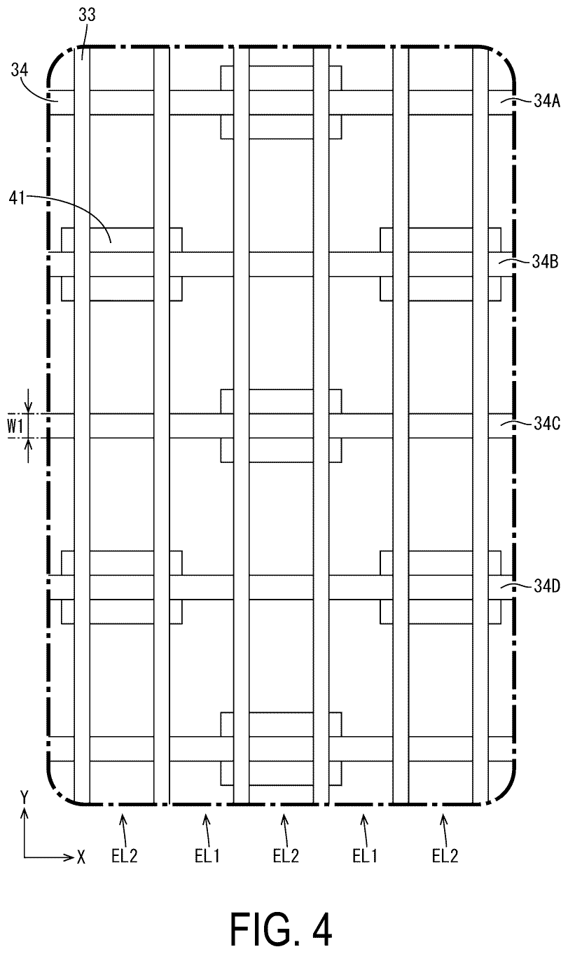

FIG. 4 is a plan view illustrating a layout of the source wiring lines 33, the gate wiring lines 34, and the spacer light blocking portions 41 of the array substrate 30. The spacer light blocking portions 41 are provided at locations overlapping the gate wiring lines 34 in every other second electrode row EL2.

Further, the gate wiring lines 34 overlapping the spacer light blocking portions 41 in one second electrode row EL2 do not overlap the spacer light blocking portions 41 in another second electrode row EL2 adjacent thereto with the first electrode row EL1 interposed therebetween. That is, as illustrated in FIG. 4, when the plurality of gate wiring lines 34 are represented by a first gate wiring line 34A, a second gate wiring line 34B, a third gate wiring line 34C, and a fourth gate wiring line 34D in this order in the Y direction, the spacer light blocking portions 41 in one second electrode row EL2 are provided at locations overlapping the first gate wiring line 34A and the third gate wiring line 34C. Further, the spacer light blocking portions 41 in another second electrode row EL2 adjacent to the one second electrode row EL2 with the first electrode row EL1 interposed therebetween are provided at locations overlapping the second gate wiring line 34B and the fourth gate wiring line 34D.

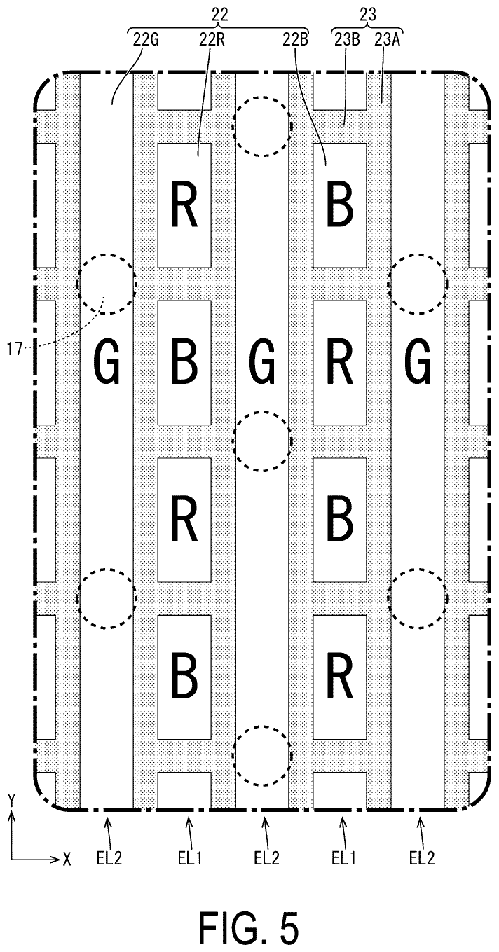

As illustrated in FIG. 5, the color filters 22 and black matrices 23 are provided in the display region AA of the counter substrate 20. The color filters 22 include the R color filter 22R, the G color filter 22G, and the B color filter 22B. The color filters 22R, 22G, 22B each have a configuration in which pigments are mixed in a resin material so that the transmitted light exhibits that color.

The color filters 22 are disposed at locations overlapping the pixel electrodes 38 of the array substrate 30 in a plan view. The R color filter 22R and the B color filter 22B overlap the pixel electrodes 38 of the first electrode row EL1 in a plan view and are alternately disposed in the Y direction. On the other hand, the G color filter 22G overlaps the pixel electrodes 38 of the second electrode row EL2 in a plan view and is disposed in the Y direction. One subpixel is formed by a set of one pixel electrode 38 and one of the color filters 22R, 22G, or 22B overlapping the pixel electrode 38. The subpixels including the color filters 22R, 22G, 22B are referred to as an R pixel, a G pixel, and a B pixel, respectively.

In the liquid crystal panel 10 according to the present embodiment, the first electrode row ELL in which the R pixels and the B pixels are alternately arrayed and the second electrode row EL2 in which the G pixels are arrayed are alternately arrayed in the X direction. Further, the R pixels and the B pixels are alternately arrayed in two first electrode rows EL1 adjacent to each other with the second electrode row EL2 interposed therebetween. That is, the R pixels and the B pixels are alternately arrayed in the X direction with the G pixels interposed therebetween. That is, the pixel layout of the liquid crystal panel 10 according to the present embodiment is a PenTile arrangement. According to the PenTile arrangement, as compared with a stripe arrangement in the related art in which the R pixel, the G pixel, and the B pixel are arrayed along each electrode row, it is possible to decrease the number of subpixels included in one pixel and realize subpixel rendering in which the apparent (specification) resolution is increased.

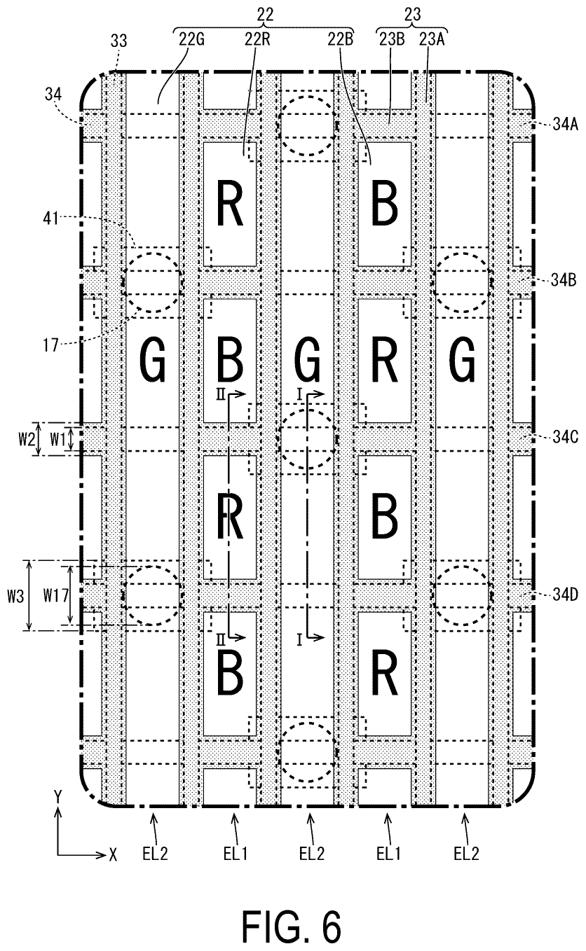

As illustrated in FIG. 5 and FIG. 6, the black matrices 23 are provided at locations overlapping the source wiring lines 33 and the gate wiring lines 34 of the array substrate 30 in a plan view. The black matrices 23 are formed wider than the source wiring line 33 and the gate wiring line 34. The black matrices 23 prevent color mixing in which light of each color transmitted through the color filters 22 is mixed.

Of the black matrices 23, a portion overlapping the source wiring line 33 and extending in the Y direction is represented by a first black matrix 23A. The first black matrix 23A is interposed between the R color filter 22R and the G color filter 22G and between the B color filter 22B and the G color filter 22G to prevent color mixing.

Further, of the black matrices 23, a portion overlapping the gate wiring line 34 and extending in the X direction is represented by a second black matrix 23B (example of second light blocking portion). The second black matrix 23B is disposed between the R color filter 22R and the B color filter 22B in a portion overlapping the gate wiring line 34, and prevents color mixing of those colors. The second black matrix 23B is not provided in the G color filter 22G.

As illustrated in FIG. 5 and FIG. 6, the plurality of spacers 17 are provided along the second electrode row EL2 where the G color filter 22G is disposed. A planar shape of the spacer 17 is not particularly limited, but is circular in the present embodiment. Like the spacer light blocking portions 41 described above, the spacers 17 are alternately provided at locations overlapping the gate wiring lines 34 in the second electrode row EL2.

Further, the gate wiring lines 34 overlapping the spacers 17 in one second electrode row EL2 do not overlap the spacers 17 in another second electrode row EL2 adjacent thereto with the first electrode row EL1 interposed therebetween. That is, as illustrated in FIG. 6, the spacers 17 in one second electrode row EL2 are provided at locations overlapping the first gate wiring line 34A and the third gate wiring line 34C. Further, the spacers 17 in another second electrode row EL2 adjacent to the one second electrode row EL2 with the first electrode row EL1 interposed therebetween are provided at locations overlapping the second gate wiring line 34B and the fourth gate wiring line 34D.

As illustrated in FIG. 6, a length W3 of the spacer light blocking portion 41 in the Y direction is sufficiently long as compared with a length (line width) W1 of the gate wiring line 34 in the Y direction and a length W2 of the second black matrix 23B in the Y direction, and is greater than a length W17 of the spacer 17 in the Y direction. That is, the relationship W3>W17>W2>W1 is established. Further, a length of the spacer 17 in the X direction (equal to W17 in the present embodiment with the planar shape of the spacer 17 being circular) is less than a distance between the R pixel and the B pixel adjacent to each other in the X direction with the G pixel interposed therebetween.

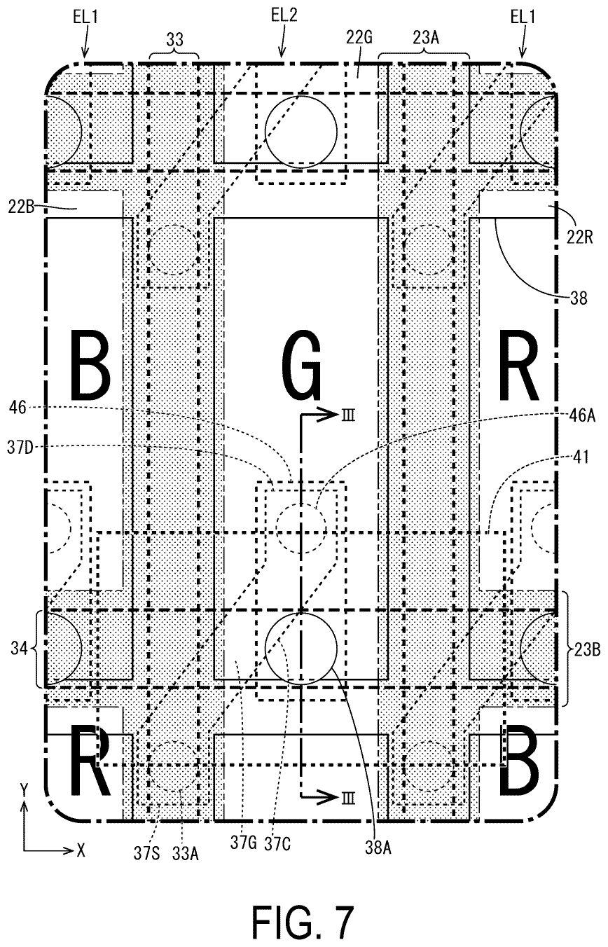

Next, a planar layout and a layer configuration of one subpixel of the liquid crystal panel 10 will be described with reference to FIG. 7 to FIG. 10. As illustrated in FIG. 7 and FIG. 8, the array substrate 30 includes, in order from the glass substrate 30A side, the spacer light blocking portion 41 formed of a first light blocking film, a base coat film 42, a semiconductor portion (channel region of the TFT 37) 37C and a drain electrode 37D formed of a semiconductor film, a gate insulating film 43, the gate wiring line 34 (including a gate electrode 37G) formed of a gate metal film, a first insulating film 44, the source wiring line 33 (including a source electrode 37S) formed of a source metal film, a second insulating film 45, a connection electrode 46 formed of a first transparent conductive film, a third insulating film 47, the pixel electrode 38 formed of a second transparent conductive film, a fourth insulating film 48, a fifth insulating film 49, and a common electrode 39 formed of a third transparent conductive film. Note that, in FIG. 7, the spacer 17 is not illustrated in order to clearly illustrate other members.

As illustrated in FIG. 7, the pixel electrode 38 is disposed in a region surrounded by two source wiring lines 33 spaced apart in the X direction and two gate wiring lines 34 spaced apart in the Y direction. The pixel electrode 38 has a vertically long rectangular shape in a plan view in accordance with a planar shape of this region. The pixel electrode 38 includes a contact portion 38A interlayer-connected to the connection electrode 46.

The semiconductor film has a substantially S-like shape in a plan view and, in a portion overlapping the gate wiring line 34 (gate electrode 37G), is inclined relative to the Y direction and serves as the channel region 37C of the TFT 37. The semiconductor film, except for the portion overlapping the gate wiring line 34, is formed and processed so as to function as a conductive portion. Therefore, one end portion of the semiconductor film provided at a center location between two source wiring lines 33 in the X direction functions as the drain electrode 37D. Further, the other end portion of the semiconductor film is connected to the source wiring line 33 (source electrode 37S) by a contact portion 33A.

The connection electrode 46 is provided at a location overlapping the pixel electrode 38 and between two source wiring lines 33 spaced apart in the X direction. The connection electrode 46 connects the pixel electrode 38 and the drain electrode 37D. The connection electrode 46 has a vertically long rectangular shape in a plan view, and includes, at one end portion thereof, a contact portion 46A overlapping and interlayer-connected to the drain electrode 37D. Further, the other end portion of the connection electrode 46 is interlayer-connected to the contact portion 38A of the pixel electrode 38.

As illustrated in FIG. 8, the common electrode 39 is disposed overlapping all pixel electrodes 38 on an upper layer side with the fifth insulating film 49 interposed therebetween.

Note that the first light blocking film may be provided in portions other than the spacer light blocking portions 41. More specifically, the first light blocking film may also be provided in a portion of the TFT 37 serving as the channel region 37C (portion of the semiconductor film overlapping the gate electrode 37G in a plan view) where the spacer light blocking portion 41 is not provided. This makes it possible to block light emitted from the backlight device 80 to the channel region 37C of the TFT 37 as well. As a result, it is possible to suppress fluctuation in the characteristics of the TFT 37 which may occur when the channel region 37C is irradiated with light.

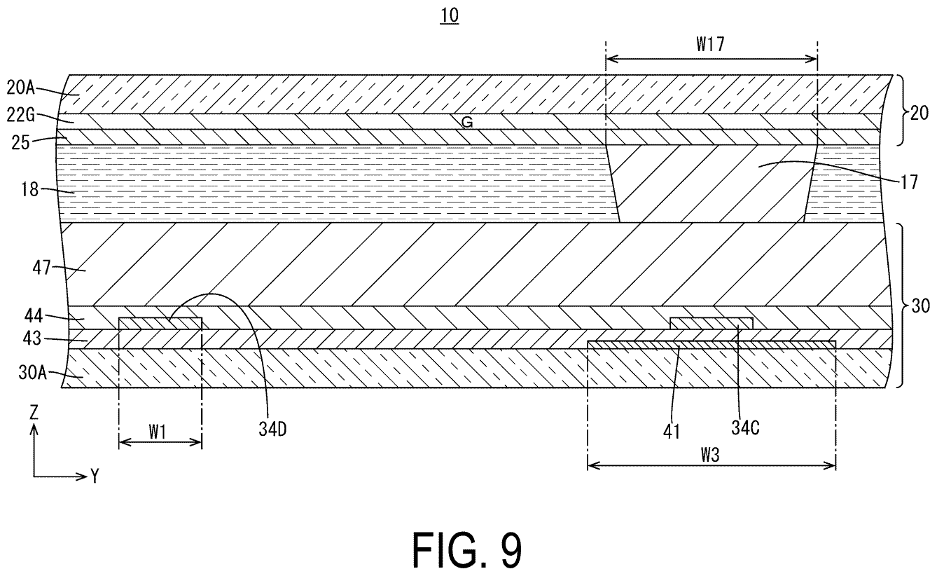

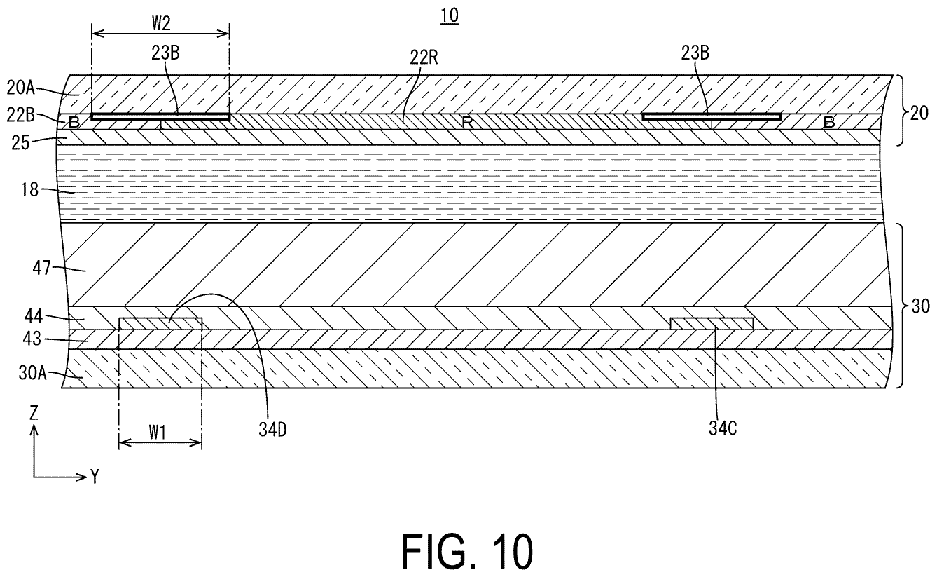

As illustrated in FIG. 8 to FIG. 10, in the counter substrate 20, the black matrices 23 (first black matrix 23A, second black matrix 23B) formed of the second light blocking film, the color filters 22 (red color filter 22R, blue color filter 22B, green color filter 22G), and an overcoat film 25 are layered in this order from the glass substrate 20A side. The overcoat film 25 is solidly formed on the color filters 22. A front face of the counter substrate 20 is leveled by the overcoat film 25. Note that, in FIG. 9 and FIG. 10, the fifth insulating film 49 (refer to FIG. 8) and the common electrode 39 (refer to FIG. 8) are not illustrated.

The first light blocking film and the second light blocking film are made of a light blocking material such as a metal (including an alloy) such as titanium (Ti) or a black resin, for example. The gate metal film and the source metal film are single-layer films made of one type of metal material or a layered film or alloy made of different types of metal materials, and thus have conductivity and light-blocking properties. The first transparent conductive film, the second transparent conductive film, and the third transparent conductive film are made of a transparent conductive material such as indium tin oxide (ITO) or indium zinc oxide (IZO), for example.

The base coat film 42, the gate insulating film 43, the first insulating film 44, the second insulating film 45, and the fifth insulating film 49 are all made of an inorganic material (inorganic resin material) such as a single-layer film or a layered film of silicon oxide (SiO) or silicon nitride (SiN), for example. The third insulating film 47, the fourth insulating film 48, and the overcoat film 25 are made of an organic material (organic resin material) such as PMMA (acrylic resin), for example. The third insulating film 47 and the fourth insulating film 48 are typically thicker than other insulating films made of an inorganic material. After the contact portion 46A of the connection electrode 46 is formed, the fourth insulating film 48 fills the contact holes and levels the surface.

The semiconductor film is made of an oxide semiconductor material, but may be made of another semiconductor material. As the oxide semiconductor material, an oxide semiconductor material containing at least one metal element among In, Ga, and Zn, for example, may be used.

Next, actions and effects of the liquid crystal panel 10 having the configuration described above will be described. The liquid crystal panel 10, by the pixel layout described above, can realize subpixel rendering of the so-called PenTile arrangement and can realize apparent high resolution. In this pixel layout, when the spacers 17 are provided at locations overlapping the G color filter 22G in a plan view, the spacer light blocking portions 41 provided at locations overlapping the spacers 17 also overlap the G color filter 22G in a plan view.

Thus, the spacer light blocking portions 41 overlap the G color filter 22G but do not overlap the R color filters 22R and the B color filters 22B. As a result, it is possible to suppress a situation in which the aperture ratios of the R pixel and the B pixel are reduced due to the arrangement of the spacers 17. On the other hand, the G pixels are not alternately provided like the R pixels and the B pixels, but are arranged along the second electrode row EL2, facilitating formation of the G pixel in a large planar size as compared with the R pixel and the B pixel. Thus, even if the spacers 17 are arranged overlapping the G color filter 22G, the aperture ratio of the G pixel can be maintained to a certain degree or higher. For example, given that the aperture ratios of the R pixel and the B pixel are each 1.0, the aperture ratio of the G pixel is preferably from 1.3 to 2.0. As a result, the aperture ratio (transmittance of white display) of the liquid crystal panel 10 as a whole can be improved.

Further, the spacers 17 are not disposed at a boundary between the subpixels of different colors, facilitating suppression of a situation in which a variation occurs in the aperture ratio of the subpixels of each color due to a positional displacement when the array substrate 30 and the counter substrate 20 are bonded to each other. Accordingly, according to the liquid crystal panel 10 of the present embodiment, it is possible to suppress both a reduction in the aperture ratio overall and the variation in the aperture ratio of the subpixels of each color while realizing subpixel rendering of the PenTile arrangement.

Further, the second black matrix 23B of the counter substrate 20 is disposed at a location overlapping a boundary between the R color filter 22R and the B color filter 22B in a plan view, but is not disposed at a location overlapping the G color filter 22G in a plan view. Accordingly, it is possible to facilitate further suppression of a reduction in the aperture ratio of the G pixel and improve a transmittance of green light having high visibility for humans.

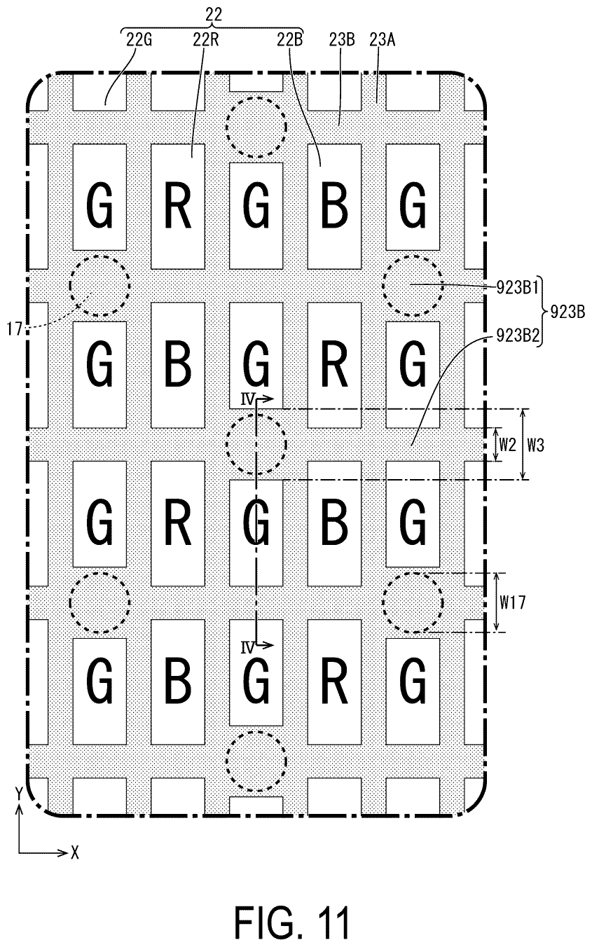

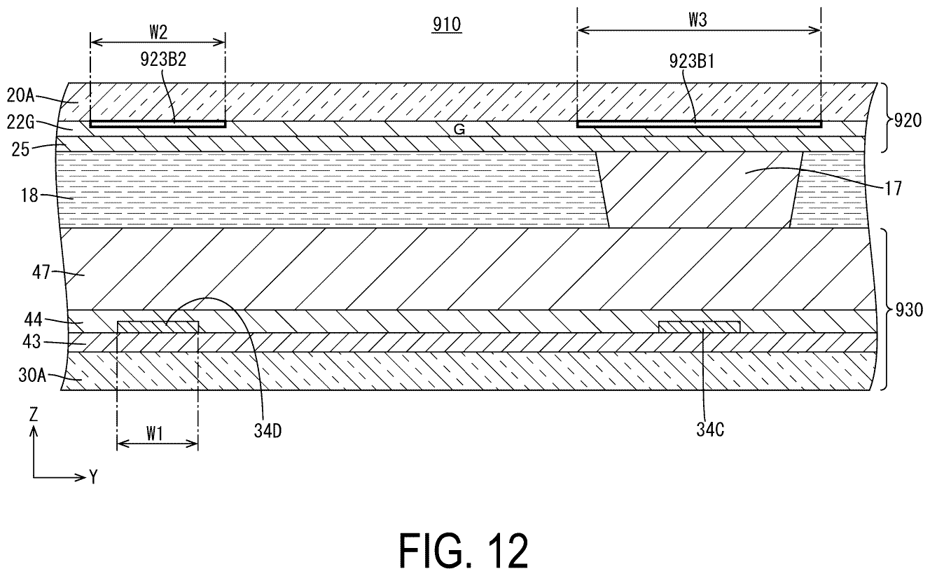

Here, the reason that a reduction in aperture ratio of the G pixel can be further suppressed will be described with reference to a liquid crystal panel 910 according to a first comparative example. As illustrated in FIG. 11 and FIG. 12, in the liquid crystal panel 910, second black matrices 923B are also provided at the boundary between the G pixels adjacent to each other in the Y direction. In this case, a second black matrix 923B1 overlapping the spacer 17 in a plan view can prevent light leakage from an arrangement location of the spacer 17, eliminating the need to provide the spacer light blocking portion 41 in the array substrate 30. A length of the second black matrix 923B1 in the Y direction is equal to the length W3 of the spacer light blocking portion 41 in the Y direction and thus, due to this difference, there is no change in the aperture ratio of the G pixel.

On the other hand, according to a second black matrix 923B2 at a portion of a boundary of the G pixel where the spacer 17 is not disposed, the change in aperture ratio of the G pixel is reduced. A length W2 of the second black matrix 923B2 in the Y direction needs to be formed longer than the length W1 of the gate wiring line 34 overlapping the second black matrix 923B2 in the Y direction. More specifically, the length W2 of the second black matrix 923B2 in the Y direction needs to be formed so as to satisfy the relationship W2>W1+2ΔY, where ΔY is a maximum value (maximum fitting misalignment amount) of the positional displacement in the Y direction when the array substrate 30 and the counter substrate 20 are bonded to each other. The maximum fitting misalignment amount ΔY is, for example, about 1.0 μm to 2.5 μm. According to the liquid crystal panel 10 of the present embodiment, it is not necessary to form the light blocking portion larger by 2ΔY, and the change in the aperture ratio of the G pixel can be more readily suppressed.

Note that preferably lengths of the R pixel and the B pixel in the X direction are the same. In this way, even if the positional displacement in the X direction when the array substrate 30 and the counter substrate 20 are bonded to each other occurs and the aperture ratios of the R pixel and the B pixel change, these aperture ratios change at the same rate. As a result, it is possible to suppress a situation in which the chromaticity changes to a value different from the design value.

### Second Embodiment

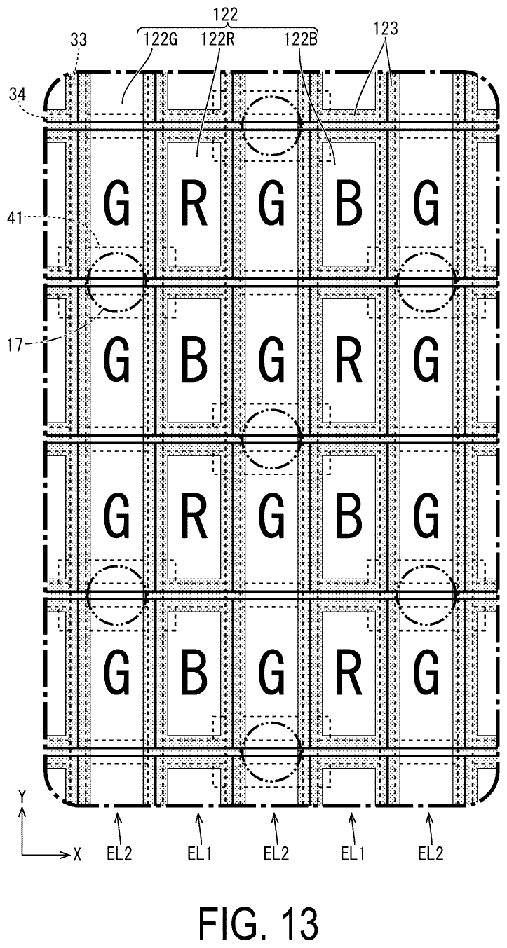

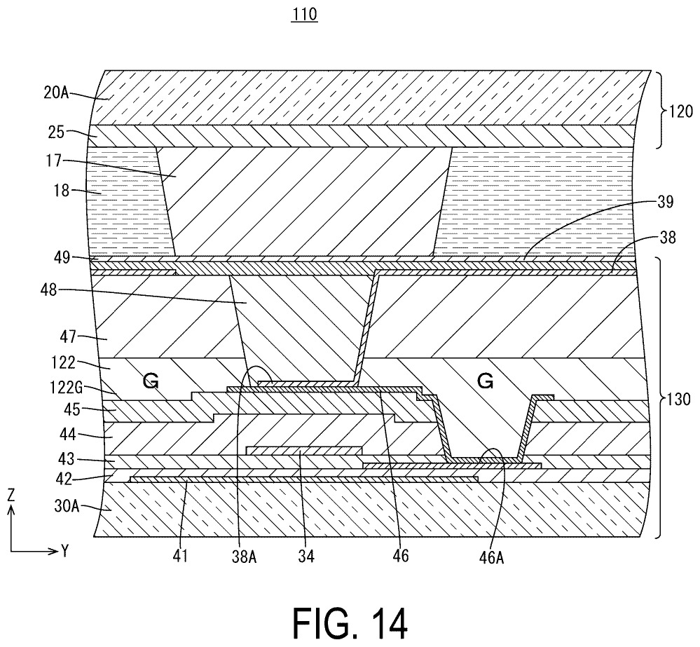

A liquid crystal panel 110 according to a second embodiment will be described with reference to FIG. 13 and FIG. 14. The present embodiment differs from the first embodiment in that color filters 122 and a black matrix 123 are formed on an array substrate 130. Repetitive descriptions of structures, actions, and effects similar to those of the first embodiment will be omitted.

The liquid crystal panel 110 has a so-called color filter on array (COA) structure in which the color filters 122 are provided on the array substrate 130. In the array substrate 130, as illustrated in FIG. 14, the color filters 122 are provided between the connection electrodes 46 and the third insulating film 47. Further, the black matrix 123 is provided in a lower layer of the common electrode 39 and thereunder, and not formed on the counter substrate 120.

In this way, even if positional displacement occurs when the array substrate 130 and the counter substrate 120 are bonded to each other, the aperture ratios of all subpixels (R pixel, B pixel, and G pixel) do not change by this displacement. Accordingly, it is possible to suppress a situation in which the chromaticity changes to a value different from the design value.

### Third Embodiment

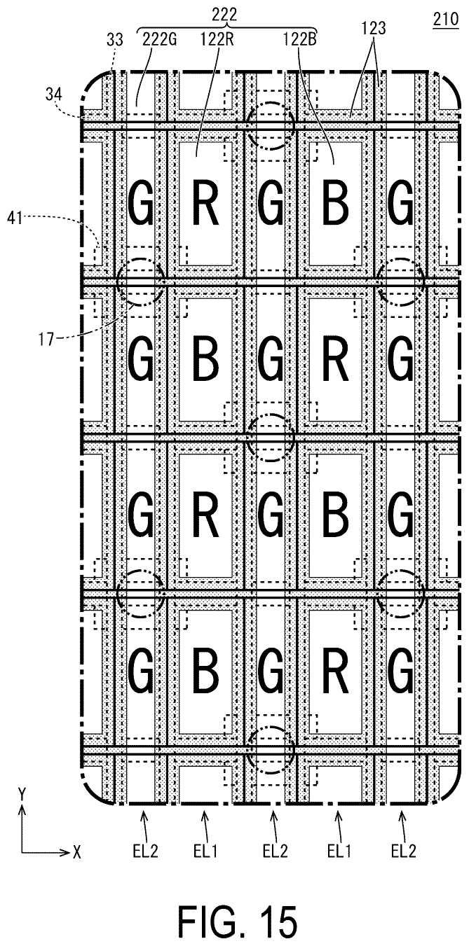

A liquid crystal panel 210 according to a third embodiment will be described with reference to FIG. 15. In the present embodiment, the length of the G pixel in the X direction differs from that in the second embodiment. Repetitive descriptions of structures, actions, and effects similar to those of the first and second embodiments will be omitted.

The liquid crystal panel 210 has a COA structure, and the length of the G pixel in the X direction is short as compared with those of the R pixel and the B pixel. That is, in color filters 222, the length of a G color filter 222G in the X direction is short as compared with lengths of an R color filter 122R and a B color filter 122B in the X direction.

As described above, given that the aperture ratio of each of the R pixel and the B pixel is 1.0, the aperture ratio of the G pixel is preferably from 1.3 to 2.0. With the configuration described above, it is easy to adjust the aperture ratio of the G pixel to a smaller size such as, for example, 1.3.

### Other Embodiments

The techniques described herein are not limited to the embodiments described above with reference to the drawings, and embodiments such as those described below are also included within the technical scope of the disclosure.
(1) The layer configuration of the liquid crystal panels 10, 110, 120 and the planar layout of each layer are not limited to those illustrated in the drawings. For example, the common electrode 39 may be provided at the counter substrates 20, 120.
(2) The techniques described in the present specification can also be applied to a display panel or the like in which functional organic molecules (a medium layer) other than the liquid crystal layer 18 are interposed.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display panel comprising:
an array substrate;
a counter substrate; and
a plurality of spacers configured to maintain a gap between the array substrate and the counter substrate,
wherein the array substrate and the counter substrate are disposed facing each other,
the array substrate includes
a plurality of source wiring lines extending in a first direction,
a plurality of gate wiring lines extending in a second direction intersecting the first direction,
a first electrode row obtained by a plurality of pixel electrodes being arrayed in the first direction,
a second electrode row adjacent to the first electrode row and obtained by a plurality of pixel electrodes being arrayed in the first direction, and
a plurality of first light blocking portions disposed at locations overlapping the plurality of spacers in a plan view,
one of the counter substrate or the array substrate includes
a first color filter and a second color filter overlapping the plurality of pixel electrodes of the first electrode row in a plan view and alternately provided in the first direction, and
a third color filter overlapping the plurality of pixel electrodes of the second electrode row in a plan view and provided in the first direction, and
the plurality of spacers are provided in the second electrode row in which the third color filter is disposed.

2. The display panel according to claim 1,
wherein the first color filter is a red color filter,
the second color filter is a blue color filter, and
the third color filter is a green color filter.

3. The display panel according to claim 1,
wherein the counter substrate
includes a second light blocking portion overlapping a boundary between the first color filter and the second color filter in a plan view, and
does not include a light blocking portion overlapping the third color filter in a plan view.

4. The display panel according to claim 3,
wherein a length of the second light blocking portion in the first direction is greater than a length of the plurality of gate wiring lines in the first direction.

5. The display panel according to claim 1,
wherein the plurality of spacers and the plurality of first light blocking portions are provided at locations overlapping the plurality of gate wiring lines in a plan view.

6. The display panel according to claim 1, comprising:
a plurality of the second electrode rows,
wherein, when the plurality of gate wiring lines arranged in order in the first direction are represented by a first gate wiring line, a second gate wiring line, a third gate wiring line, and a fourth gate wiring line,
first light blocking portions of the plurality of first light blocking portions in one of the plurality of second electrode rows are provided at locations overlapping the first gate wiring line and the third gate wiring line, and
first light blocking portions of the plurality of first light blocking portions in another second electrode row of the plurality of second electrode rows, the other second electrode row being adjacent to the one second electrode row with the first electrode row interposed therebetween, are provided at locations overlapping the second gate wiring line and the fourth gate wiring line.

7. The display panel according to claim 1,
wherein the array substrate includes the first color filter, the second color filter, and the third color filter.

8. The display panel according to claim 7,
wherein a length of the third color filter in the second direction is less than a length of the first color filter in the second direction and a length of the second color filter in the second direction.

9. The display panel according to claim 1, comprising:
a liquid crystal layer between the array substrate and the counter substrate.

10. A display device comprising:
the display panel according to claim 1.
